(19) United States
(12) Patent Application Publication
(10) Pub. No.: US 2025/0201456 A1
(43) Pub. Date: Jun. 19, 2025

(54) A magnetic elastomer and method of preparing the same

(71) Applicant: Ningxia Magvalley Noval Materials Technology Co., Ltd., Ningxia (CN)

(72) Inventors: Xinan WANG, Ningxia (CN); Benpei CHENG, Ningxia (CN); Siyu LIAO, Ningxia (CN)

(73) Assignee: Ningxia Magvalley Noval Materials Technology Co., Ltd., Ningxia (CN)

(21) Appl. No.: 18/978,416

(22) Filed: Dec. 12, 2024

(30) Foreign Application Priority Data
Dec. 14, 2023 (CN) 202311723536.1

(51) Int. Cl. H01F 1/059; C08K 3/08; C08K 3/22; H01F 1/057; H01F 41/02

(52) U.S. Cl. CPC H01F 1/059; C08K 3/08; C08K 3/22; H01F 1/0571; H01F 41/0266; C08K 2003/0856; C08K 2003/2265; C08K 2201/005; C08K 2201/01; C08K 2201/014

(57) ABSTRACT

A magnetic elastomer and a method of preparing the same are provided. The magnetic elastomer includes the following components based on the total weight of the magnetic elastomer, 50 wt %-85 wt % of a magnet powder, 5 wt %-30 wt % of a binder, and 1 wt %-30 wt % of a processing aid. The magnet powder includes samarium iron nitrogen magnet powder and/or neodymium iron nitrogen magnet powder. When present, the samarium iron nitrogen magnet powder has an x50 particle size of less than or equal to 2.4 μm; when present, the neodymium iron nitrogen magnet powder has an x50 particle size of less than or equal to 2.0 μm.

### FIELD

The present disclosure discloses a magnetic elastomer with good permanent magnetic properties and certain tensile properties, flexural properties and/or flame retardant properties and a method of preparing the same.

### BACKGROUND

With the development of flexible components or flexible magnetic electronic devices with magnetic adsorption functions in wearable devices and artificial intelligence devices, magnetic elastic materials are increasingly becoming one of the key materials for the flexibility of magnetic electronic devices in related fields. Current magnetic elastic materials are subject to the limitations of material development and cannot simultaneously have high magnetism and good tensile and flexural properties.

### SUMMARY

The present disclosure provides a magnetic elastomer comprising the following components based on the total weight of the magnetic elastomer:
50 wt %-85 wt % of a magnet powder,
5 wt %-30 wt % of a binder, and
1 wt %-30 wt % of a processing aid,
wherein, the magnet powder comprises samarium iron nitrogen magnet powder and/or neodymium iron nitrogen magnet powder; and
wherein, when present, the samarium iron nitrogen magnet powder has an x50 particle size of less than or equal to 2.4 μm; when present, the neodymium iron nitrogen magnet powder has an x50 particle size of less than or equal to 2.0 μm.

In one embodiment, the binder is a thermoplastic elastic material having a melting point of between 80 and 200 degrees Celsius, preferably selected from the group consisting of styrene thermoplastic elastomers, olefin thermoplastic elastomers, diene thermoplastic elastomers, vinyl chloride thermoplastic elastomers, urethane (TPU) thermoplastic elastomers, ester (TPEE) thermoplastic elastomers, amide (TPAE) thermoplastic elastomers, organic fluorine (TPF) thermoplastic elastomers, thermoplastic resins (EEA) and silicone thermoplastic elastomers.

In one embodiment, the processing aid comprises at least one of a coupling agent, a plasticizer, a mold release lubricant, and a flame retardant.

In one embodiment, the magnet powder further comprises a second magnet powder; preferably, the second magnet powder are selected from the group consisting of ferrite magnet powders and neodymium iron boron magnet powders.

SmFeN magnet powder and/or NdFeN magnet powder can be present in a total amount of 15-100 wt %, such as 50-100 wt %, based on the total weight of the magnet powder; the second magnet powder can be present in a total amount of 0-85 wt %, such as 0-25 wt %, based on the total weight of the magnet powder.

In one embodiment, the SmFeN magnet powder (i.e., samarium iron nitrogen magnet powder) has an x10 particle size of 0.6-1.0 μm, an x50 particle size of 1.9-2.4 μm, and an x99 particle size of 5.5-7.2 μm; and/or

NdFeN magnet powder (i.e., neodymium iron nitrogen magnet powder) has an x10 particle size of 0.5-0.8 μm, an x50 particle size of 1.5-2.0 μm, and an x99 particle size of 4.5-6.2 μm.

In one embodiment, the SmFeN magnet powder has a maximum magnetic energy product (BH)max of 28-41 MGOe, a remanence Br of 12.5-15.0 kGs, and an intrinsic coercivity Hcj of 8.0-12.0 kOe; and/or

NdFeN magnet powder has a maximum magnetic energy product (BH)max of 9-22 MGOe, a remanence Br of 10.0-14.0 kGs, and an intrinsic coercivity Hcj of 3.0-8.0 kOe.

In one embodiment, the magnetic elastomer comprises the following components based on the total weight of the magnetic elastomer:
80 wt %-85 wt % of the magnet powder,
8 wt %-20 wt % of the binder,
1 wt %-3 wt % of the processing aid,
wherein the processing aid does not contain a flame retardant;
preferably, the magnetic elastomer has a maximum magnetic energy product (BH)max of above 8 MGOe, a tensile strength of between 2 MPa and 10 MPa, an elongation at break of between 2% and 5%, a Shore hardness of below 90 A, and a flexural modulus of between 90 MPa and 200 MPa.

In one embodiment, the magnetic elastomer comprises the following components based on the total weight of the magnetic elastomer:
55 wt %-80 wt % of the magnet powder,
15 wt %-25 wt % of the binder, and
2 wt %-30 wt % of the processing aid,
wherein the processing aid comprises a flame retardant;
preferably, the magnetic elastomer has a maximum magnetic energy product (BH)max of between 4 and 8 MGOe, a tensile strength of below 2 MPa, an elongation at break of between 3% and 500%, a Shore hardness of below 70 A, a flexural elastic modulus of between 30 and 100 MPa, and a flame retardance rating of V1 or above, tested according to UL94 standard.

In one embodiment, the magnetic elastomer comprises the following components based on the total weight of the magnetic elastomer:
50 wt %-70 wt % of the magnet powder,
15 wt %-30 wt % of the binder, and
10 wt %-25 wt % of the processing aid,
wherein the processing aid comprises a flame retardant;
preferably, the magnetic elastomer has a maximum magnetic energy product (BH)max of between 1 and 4 MGOe, an elongation at break of between 500% and 2000%, a Shore hardness of below 50 A, a flexural elastic modulus of between 2 and 50 MPa, and a flame retardance rating of V0 or above, tested according to UL94 standard.

The present disclosure also provides a method for preparing a magnetic elastomer, comprising:

S1. providing a magnetic elastomer composition comprising the following components based on the total weight of the magnetic elastomer composition:
50 wt %-85 wt % of a magnet powder,
8 wt %-30 wt % of a binder, and
1 wt %-30 wt % of a processing aid,
wherein, the magnet powder comprises samarium iron nitrogen magnet powder and/or neodymium iron nitrogen magnet powder; and
wherein, when present, the samarium iron nitrogen magnet powder has an x50 particle size of 1.9-2.4 μm; when present, the neodymium iron nitrogen magnet powder has an x50 particle size of 1.5-2.0 μm;

S2. molding the magnetic elastomer composition under a condition having an orientation field of greater than 5 kOe to obtain the magnetic elastomer.

The present disclosure also provides an article comprising the magnetic elastomer of the present disclosure.

The magnetic elastomer of the present disclosure has good permanent magnetic properties and mechanical properties, and is very suitable for making various products such as flexible components or flexible magnetic electronic devices with magnetic adsorption functions in wearable devices and artificial intelligence devices.

### DETAILED DESCRIPTION OF EMBODIMENTS

The present disclosure is further described in detail below through the embodiments. Through these descriptions, the characteristics and advantages of the present disclosure will become clearer and more specific.

The word “exemplary” is used exclusively herein to mean “serving as an example, embodiment, or illustration.” Any embodiment described herein as “exemplary” is not necessarily to be construed as preferred or advantageous over other embodiments.

The technical features involved in different embodiments of the present disclosure described below can be combined with each other as long as they do not conflict with each other.

The present disclosure provides a magnetic elastomer comprising the following components based on the total weight of the magnetic elastomer:
50 wt %-85 wt % of a magnet powder,
5 wt %-30 wt % of a binder, and
1 wt %-30 wt % of a processing aid,
wherein, the magnet powder comprises a samarium iron nitrogen magnet powder (also referring to SmFeN magnet powder) and/or a neodymium iron nitrogen magnet powder (also referring to NdFeN magnet powder); and
wherein, when present, the samarium iron nitrogen magnet powder has an x50 particle size of less than or equal to 2.4 μm; when present, the neodymium iron nitrogen magnet powder has an x50 particle size of less than or equal to 2.0 μm.

The inventors of the present disclosure have discovered that by selecting samarium iron nitride magnet powder and/or neodymium iron nitride magnet powder with a specific particle size range and distribution characteristics, they can be compounded with a substrate to prepare a new type of magnetic material with high magnetic properties and good flexibility, which can be suitable for the needs of flexible components or flexible magnetic electronic devices with magnetic adsorption functions in wearable devices and artificial intelligence devices.

In one embodiment, the samarium iron nitrogen magnet powder that can be used in the present disclosure may have an x10 particle size of 0.6-1.0 μm, an x50 particle size of 1.9-2.4 μm, and an x99 particle size of 5.5-7.2 μm. Furthermore, the samarium iron nitrogen magnet powder may have a maximum magnetic energy product (BH)max of 28-41 MGOe, a remanence Br of 12.5-15.0 kGs, and an intrinsic coercivity Hcj of 8.0-12.0 kOe.

In one embodiment, the NdFeN magnet powder that can be used in the present disclosure may have an x10 particle size of 0.5-0.8 μm, an x50 particle size of 1.5-2.0 μm, and an x99 particle size of 4.5-6.2 μm. Furthermore, the NdFeN magnet powder may have a maximum magnetic energy product (BH)max of 9-22 MGOe, a remanence Br of 10.0-14.0 kGs, and an intrinsic coercivity Hcj of 3.0-8.0 kOe.

The above-mentioned samarium iron nitride magnet powder and neodymium iron nitride magnet powder can be purchased from Ningxia Magvalley Noval Materials Technology Co., Ltd. These types of magnet powders are permanent magnet powders with high magnetic properties and submicron particle size.

In this disclosure, “x10 particle size” means that in the particle size distribution of the magnet powder, particles having a particle size smaller than “x10 particle size” account for 10% of the total number of particles; “x90 particle size” means that in the particle size distribution of the magnet powder, particles having a particle size larger than “x90 particle size” account for 10% of the total number of particles; “x50 particle size” means the median particle size of the magnet powder, and in the particle size distribution, particles having a particle size smaller than “x50 particle size” and larger than “x50 particle size” each account for 50%. These can be measured by a particle size analyzer.

As demonstrated in this disclosure, the samarium iron nitrogen magnet powder and/or neodymium iron nitrogen magnet powder with a specific particle size range and distribution characteristics and uniform magnetism can be well combined with the binder, while ensuring that the obtained magnetic elastomer has a smooth surface, and is very suitable for manufacturing flexible high-performance magnets. The magnetic elastomer can be used to prepare a new magnetic material with both high magnetic properties and good flexibility, while having good corrosion resistance and oxidation resistance due to the characteristics of nitrides. The particle size characteristics of samarium iron nitrogen magnet powder and/or neodymium iron nitrogen magnet powder are very critical for obtaining a new magnetic material with high magnetic properties and good flexibility. In particular, when coarser samarium iron nitrogen magnet powder and/or neodymium iron nitrogen magnet powder are used, the magnetic properties and/or mechanical properties (especially flexibility) of the resulting magnetic elastomer will be significantly reduced, which is disadvantageous for this disclosure.

In one embodiment, the magnet powder may further include a second magnet powder. Preferably, the second magnet powder are selected from the group consisting of ferrite magnet powders and neodymium iron boron magnet powders. In order to match with samarium iron nitrogen magnet powders and/or neodymium iron nitrogen magnet powders, these second magnet powders may generally have an x50 particle size of 1-100 microns. For example, ferrite magnet powders may generally have an x50 particle size of 1.4-2.0 μm. The neodymium iron boron magnet powders may generally have an x50 particle size of 5-100 μm.

By combining second magnet powders such as ferrite magnet powder with SmFeN magnet powder and/or NdFeN magnet powder, costs can be saved while ensuring magnetic properties. In particular, the usage of flame retardants can be reduced. The required flame retardancy can still be achieved without using flame retardants or using a small amount of flame retardants.

In one embodiment, SmFeN magnet powder and/or NdFeN magnet powder can be present in a total amount of 15-100 wt %, such as 50-100 wt %, based on the total weight of the magnet powder; the second magnet powder such as ferrite magnet powder, NdFeB magnet powder, etc. can be present in a total amount of 0-85 wt %, such as 0-25 wt %, based on the total weight of the magnet powder.

The magnetic elastomer of the present disclosure may also contain a binder. The role of the binder is to increase the fluidity of the magnet powder particles and the bonding strength between them, giving the magnet mechanical properties and corrosion resistance. The selection of the binder can be determined according to the molding process and application requirements. Usually, a binder with a melting point of between 80 and 200 degrees Celsius can be selected, which can still have certain tensile and flexural properties after being molded and cooled in a high-temperature molten state, and a thermoplastic elastic material with good fluidity, large bonding force, high bonding strength, low water absorption and good dimensional stability can be selected.

For example, examples of binders include at least one of styrene-based binders (SBS, SIS, SEBS, SEPS), olefins-based binders (TPO, TPV), diene-based binders (TPB, TPI), vinyl chloride-based binders (TPVC, TCPE), urethane-based binders (TPU), ester-based binders (TPEE), amide-based binders (TPAE), organic fluorine-based binders (TPF), silicone-based binders and vinyl-based binders, etc. According to the application requirements, the selection range can also include at least one of chlorinated polyethylene, polyamide resin, thermoplastic polyimide, liquid crystal polymer, polyphenylene sulfide, polyphenylene oxide, polyolefin, modified polyolefin, polycarbonate, polymethyl methacrylate, polyether, polyether ketone, polyetherimide, polyformaldehyde, and chlorosulfonated polyethylene, and/or, at least one of copolymers, blends, and polymer alloys formed based on at least one of chlorinated polyethylene, polyamide resin, thermoplastic polyimide, liquid crystal polymer, polyphenylene sulfide, polyphenylene oxide, polyolefin, modified polyolefin, polycarbonate, polymethyl methacrylate, polyether, polyether ketone, polyetherimide, polyformaldehyde, and chlorosulfonated polyethylene. Among them, polyamide resin can include nylon 6, nylon 46, nylon 66, nylon 610, nylon 612, nylon 11, nylon 12, nylon 6-12, nylon 6-66, etc. Liquid crystal polymer can be aromatic polyester, etc. Polyolefin can be polyethylene, polypropylene, etc.

In one embodiment, the binder is a thermoplastic elastic material with a melting point of between 80 and 200 degrees Celsius, preferably selected from the group consisting of styrene thermoplastic elastomers, olefin thermoplastic elastomers, diene thermoplastic elastomers, vinyl chloride thermoplastic elastomers, urethane thermoplastic elastomers (TPU), ester thermoplastic elastomers (TPE), amide (TPAE) thermoplastic elastomers, organic fluorine (TPF) thermoplastic elastomers, thermoplastic resins (EEA) and silicone thermoplastic elastomers. These binders can be obtained commercially.

Among these materials, more preferred are the binders selected from the group consisting of urethane (TPU) thermoplastic elastomers, ester (TPEE) thermoplastic elastomers, thermoplastic resins (EEA), polypropylene (PP), etc. Using these binders can achieve the following effects: the material has good flexibility and good molding fluidity. The preferred types are selected from the group consisting of TPU, TPE, PP, EEA, nylon 12, and nylon 6 with a Shore hardness of between 0-90 A.

More preferably, a combination of urethane (TPU) thermoplastic elastomer and ester (TPEE) thermoplastic elastomer can be used as a binder, which has the following effects: while ensuring the tensile and flexural properties of the molding material, the toughness of the material can be maintained, which is suitable for the requirements of magnetic encoders and consumer electronic materials.

For processing needs, some processing aids are also included, such as at least one of a coupling agent, a plasticizer, a mold release lubricant, and a flame retardant, which can be determined according to the selected binder and the molding process. These coupling agents, plasticizers, mold release lubricants, and flame retardants can use conventional materials and can be selected according to needs.

Plasticizers and mold release lubricants can improve the performance of magnetic elastomers, and can also simplify processing conditions and improve processing efficiency to a certain extent. Flame retardants are used in conjunction with thermoplastic elastomers to increase the applicability of materials in consumer electronic products and meet strict safety requirements.

The coupling agent includes a titanate coupling agent and/or a silane coupling agent. The plasticizer includes at least one of dioctyl phthalate DOP, stearate, fatty acid, phosphate, benzene polyester, and alkyl sulfonate. The lubricant includes at least one of silicone oil, wax, fatty acid, oleic acid, polyester, synthetic ester, carboxylic acid, aluminum oxide, silicon dioxide, and titanium dioxide.

Flame retardants include organic flame retardants and inorganic flame retardants, halogen flame retardants (organic chlorides and organic bromides) and halogen-free flame retardants. Organic flame retardants include, but not limited to, flame retardants with bromine, phosphorus nitrogen, nitrogen, red phosphorus and compounds as main components, and inorganic flame retardants include but not limited to flame retardants with antimony trioxide, magnesium hydroxide, aluminum hydroxide, silicon and the like as main components. Halogen-free flame retardants are preferred, such as polyester halogen-free flame retardants.

In one embodiment, the processing aid may be present in an amount of 1 wt % to 30 wt %, such as 2 wt % to 20 wt %, based on the total weight of the magnetic elastomer.

The amounts of magnet powder, binder and processing aid can be varied according to different performance requirements. For example, in one embodiment, the magnetic elastomer comprises the following components based on the total weight of the magnetic elastomer:
80 wt %-85 wt % of the magnet powder,
8 wt %-20 wt % of the binder, and
1 wt %-3 wt % of the processing aid,
wherein, the processing aid does not contain flame retardant.

The magnetic elastomer has a maximum magnetic energy product (BH)max of above 8 MGOe, a tensile strength of between 2 MPa and 10 MPa, an elongation at break of between 2% and 5%, a Shore hardness of below 90 A, and a flexural modulus of between 90 MPa and 200 MPa. Although no flame retardant is added to the magnetic elastomer, a certain flame retardance rating can also be achieved. However, flame retardant treatment can be performed after molding.

In one embodiment, the magnetic elastomer comprises the following components based on the total weight of the magnetic elastomer:
55 wt %-80 wt % of the magnet powder,
15 wt %-25 wt % of the binder, and
2 wt %-30 wt % of the processing aid,
wherein the processing aid comprises a flame retardant.

The magnetic elastomer has a maximum magnetic energy product (BH)max of between 4 and 8 MGOe, a tensile strength of below 2 MPa, an elongation at break of between 3% and 500%, a Shore hardness of below 70 A, a flexural elastic modulus of between 30 and 100 MPa, a flame retardance rating of V1 or above according to UL94 standards.

In the magnetic elastomer, samarium iron nitrogen magnet powder and/or neodymium iron nitrogen magnet powder can be present in a total amount of 80-100 wt %, for example 80-100 wt %, based on the total weight of the magnet powder. The second magnet powder such as ferrite magnet powder, neodymium iron boron magnet powder, etc. can be present in a total amount of 0-20 wt %, for example 0-18 wt %, based on the total weight of the magnet powder.

In the magnetic elastomer, the flame retardant is added at a low ratio. the flame retardant can be present in an amount of 2 wt %-2.5 wt %, for example, 5 wt %-1.5 wt %, based on the total weight of the magnetic elastomer. Since the second magnet powder such as ferrite magnet powder can achieve flame retardant effects alone or in combination with flame retardants, and these second magnet powders are inherently magnetic, the loss of magnetic properties due to the addition of non-magnetic flame retardants can be reduced (the replacement ratio of the second magnet powder to flame retardants is between 60%-80%). It can achieve a flame retardance rating of V1 alone or in combination with other flame retardant treatment.

In one embodiment, the magnetic elastomer comprises the following components based on the total weight of the magnetic elastomer:
50 wt %-70 wt % of the magnet powder,
15 wt %-30 wt % of the binder, and
10 wt %-25 wt % of the processing aid,
wherein the processing aid comprises a flame retardant.

The magnetic elastomer has a maximum magnetic energy product (BH)max of between 1 and 4 MGOe, an elongation at break of between 500% and 2000%, a Shore hardness of below 50 A, a flexural elastic modulus of between 2 and 50 MPa, a flame retardance rating of above V0 according to UL94 standard.

In the magnetic elastomer, the samarium iron nitrogen magnet powder and/or neodymium iron nitrogen magnet powder can be present in a total amount of 15-90 wt %, for example 15-80 wt %, based on the total weight of the magnet powder; the second magnet powder such as ferrite magnet powder, neodymium iron boron magnet powder, etc. can be present in a total amount of 10-85 wt %, for example 20-85 wt %, based on the total weight of the magnet powder.

Since the second magnet powder such as ferrite magnet powder can achieve flame retardant effects alone or in combination with flame retardants, and these second magnet powders are inherently magnetic, the loss of magnetic properties due to the addition of non-magnetic flame retardants can be reduced (the replacement ratio of the second magnet powder to flame retardants is between 20% and 60%). In the magnetic elastomer, flame retardant can be present in an amount of 10 wt %-20 wt %, for example, 13 wt %-20 wt %, based on the total weight of the magnetic elastomer.

The present disclosure also provides a method for preparing a magnetic elastomer, comprising:
S1. providing a magnetic elastomer composition comprising the following components based on the total weight of the magnetic elastomer composition:
50 wt %-85 wt % of a magnet powder,
8 wt %-30 wt % of a binder, and
1 wt %-30 wt % of a processing aid,
wherein, the magnet powder comprises samarium iron nitrogen magnet powder and/or neodymium iron nitrogen magnet powder; and
wherein, when present, the samarium iron nitrogen magnet powder has an x50 particle size of 1.9-2.4 μm; when present, the neodymium iron nitrogen magnet powder has an x50 particle size of 1.5-2.0 μm;
S2. molding the magnetic elastomer composition under a condition having an orientation field of greater than 5 kOe to obtain the magnetic elastomer.

The molding process can be calendering (which may include vulcanization process), extrusion molding or injection molding, or the combination thereof.

For example, the binder can be dried first, and then the magnet powder, binder and processing aid are mixed evenly in a mixer, and then extruded into granules through an extruder. After that, the granules are injection molded in an injection molding machine. The injection molding process is carried out in an orientation field to perform magnetic field orientation.

In the case of using the calendering process, it is preferable to use an elastomeric material containing a rubber component as the binder. The mixture is kneaded using an open mill or an internal mixer, where the kneading temperature is between 50° C. and 110° C. The kneaded material is calendered using a calender to obtain a calendered magnet with the required dimension. The working temperature during the calendering process is between 50° C. and 100° C. Finally, the magnet is cut, stamped and shaped according to the requirements of the magnet size. The thickness of the calendered magnet prepared by this method can be as low as 0.1 mm, and the width can be adjusted according to specific needs. Depending on the selection of rubber, the vulcanization process can be combined if necessary.

In the case of adopting the extrusion molding process, it is preferable to use a material with a low melting point such as TPE as the binder. The mixture is kneaded in a mixer at 120° C.-250° C. to heat and melt the mixture, and then injected into an extruder with a temperature between 150° C. and 250° C. under an orientation field greater than 5 kOe. After extrusion, it is cooled for molding to obtain a magnetic elastomer.

In the case of using the injection molding process, the binder selection range is relatively wide, and the above-mentioned binders can be used alone or in a combination. The mixture is prepared into pellets by a twin-screw extruder at 120° C.-250° C. Thereafter, the pellets are melted by heating at 150° C. to 250° C., and then added to an injection molding machine under an orientation field greater than 5 kOe for injection molding to obtain the magnetic elastomer.

The magnetic elastomer of the present disclosure can be used to prepare various products, such as flexible components or flexible magnetic electronic devices with magnetic adsorption functions in wearable devices and artificial intelligence devices. These wearable devices can be worn on the wrist, head, glasses, clothing and other parts, and contacted with the human body to realize their designed functions and services, such as smart helmets, smart glasses, smart watches, smart bracelets, smart eye masks, Bluetooth headsets, TWS headsets, magnetically absorbable data cables, etc.

### Materials

### 1. SmFeN Magnet Powders

SmFeN magnet powder 1, anisotropic SmFeN magnet powder produced by Ningxia Magvalley Noval Materials Technology Co., Ltd., having a maximum magnetic energy product (BH)max of 38.7 MGOe, a remanence Br of 14.7 kGs, an intrinsic coercivity Hcj of 11.5 kOe, an x10 particle size of 0.71 μm, an x50 particle size of 2.10 μm, and an x99 particle size of 6.55 μm.

SmFeN magnet powder 2, anisotropic SmFeN magnet powder produced by Ningxia Magvalley Noval Materials Technology Co., Ltd., having a maximum magnetic energy product (BH)max of 28.8 MGOe, a remanence Br of 12.9 kGs, an intrinsic coercivity Hcj of 8.5 kOe, an x10 particle size of 0.82 μm, an x50 particle size of 2.36 μm, and an x99 particle size of 7.14 μm.

SmFeN magnet powder 3, anisotropic SmFeN magnet powder produced by Ningxia Magvalley Noval Materials Technology Co., Ltd., with a maximum magnetic energy product (BH)max of 32.2 MGOe, a remanence Br of 13.5 kGs, an intrinsic coercivity Hcj of 9.0 kOe, an x10 particle size of 0.85 μm, an x50 particle size of 2.45 μm, and an x99 particle size of 7.95 μm.

### 2. Ferrite Powders

Ferrite powder 1, ferrite powder produced by Zhejiang Dongci Toda Magnetics Co., Ltd., with a maximum magnetic energy product (BH)max of 1.8 MGOe, a remanence Br of 1.82 kGs, an intrinsic coercivity Hcj of 2.92 kOe, and an average particle size of 1.48 μm.

Ferrite powder 2, ferrite powder produced by Beikuang Magnetic Materials (Fuyang) Co., Ltd., with a maximum magnetic energy product (BH)max of 0.7 MGOe, a remanence Br of 1.74 kGs, an intrinsic coercivity Hcj of 2.76 kOe, and an average particle size of 1.69 μm.

Ferrite powder 3, ferrite powder produced by Beikuang Magnetic Materials (Fuyang) Co., Ltd., with a maximum magnetic energy product (BH)max of 0.6 MGOe, a remanence Br of 1.65 kGs, an intrinsic coercivity Hcj of 2.64 kOe, and an average particle size of 1.90 μm.

### 3. NdFeB Magnet Powders

The anisotropic NdFeB magnet powder is produced by Aichi Steel Co., Ltd., with a maximum magnetic energy product (BH) of max 41.0 MGOe, a remanence Br of 13.2 kGs, an intrinsic coercivity Hcj of 14.0 kOe, and an x50 particle size of 100 μm.

Isotropic NdFeB magnet powder is produced by Magnequench (Tianjin) Co., Ltd., with a maximum magnetic energy product (BH)max of 14.2 MGOe, a remanence Br of 8.3 kGs, an intrinsic coercivity Hcj of 12.4 kOe, and an x50 particle size of 65 μm.

### 4. NdFeN Magnet Powders

NdFeN magnet powder 1, anisotropic NdFeN magnet powder produced by Ningxia Magvalley Noval Materials Technology Co., Ltd., with a maximum magnetic energy product (BH)max of 20.3 MGOe, a remanence Br of 12.5 kGs, an intrinsic coercivity Hcj of 6.5 kOe, an x10 particle size of 0.56 μm, x50 particle size of 1.87 μm, and an x90 particle size of 5.55 μm.

NdFeN magnet powder 2, anisotropic NdFeN magnet powder produced by Ningxia Magvalley Noval Materials Technology Co., Ltd., with a maximum magnetic energy product (BH)max of 16.5 MGOe, a remanence Br of 11.9 kGs, an intrinsic coercivity Hcj of 5.0 kOe, an x10 particle size of 0.75 μm, an x50 particle size of 1.92 μm, and an x99 particle size of 5.86 μm.

NdFeN magnet powder 3, anisotropic NdFeN magnet powder produced by Ningxia Magvalley Noval Materials Technology Co., Ltd., with a maximum magnetic energy product (BH)max of 10.2 MGOe, a remanence Br of 11.5 kGs, an intrinsic coercivity Hcj of 3.5 kOe, an x10 particle size of 0.92 μm, an x50 particle size of 2.10 μm, and an x90 particle size of 6.33 μm.

### 5. Binders

TPU1, Elastollan BCF 45 A 12 P produced by BASF, with a Shore hardness of 48 A.

TPU2, Elastollan SP1150A15P produced by BASF, with a Shore hardness of 50 A.

TPU3, Elastollan 1170A10 produced by BASF, with a Shore hardness of 71 A.

TPE1, TF3ZGO-LCNT produced by KRAIBURG TPE GmbH & Co. KG, with a Shore hardness of 00-30 A.

TPE2, TF5ZGO-LCNT produced by KRAIBURG TPE GmbH & Co. KG, with a Shore hardness of 00-50 A.

TPE3, SHF 50A-3S1981 produced by GLS Corporation, USA, with a Shore hardness of 50 A.

### 6. Processing Aids

The release agent is calcium stearate YZS26.

The lubricant is PMX-200 silicone oil.

The flame retardant is KSW-03 halogen-free phosphorus-nitrogen flame retardant.

### Testing Methods of the Properties

1. The magnetic properties were measured on NIM −200 C magnetic measurement system.
2. A universal testing machine was used to test the tensile strength according to ASTM D638, the elongation at break according to ASTM D412, and the flexural modulus according to GB/T 9341-2008.
3. A vertical burn tester was used to carry out the vertical burn test according to the UL94 standards.

### Example 1

The magnetic elastomer was prepared as follows:
1. The binder TPUI was dried in a dryer at 80° C. for 2 hours.
2. 84.2 wt % of samarium iron nitrogen magnet powder 1, 13.25 wt % of TPU 1, and 2.55 wt % of the processing aids (1.41% of the release agent and 1.14% of the lubricant) were charged to a mixer and mixed for 30 minutes.
3. The temperature of each section of a twin-screw extruder was set between 130° C. and 230° C., and increased from the feed port to the discharge port. The mixed material of step 2 was fed into the feed port through an automatic feeder, and after being air-cooled on a conveyor belt, it was prepared into pellets with a diameter of 2-3 mm and a length of 3-5 mm by an automatic pelletizer.
4. The barrel temperature of the injection molding machine was set to 230° C. (actual measurement), the nozzle temperature was set to 250° C. (actual measurement), and the mold temperature was set to 50° C. (actual measurement). The electromagnetic field orientation power supply was turned on, and the orientation field was set to 6 kOe. After feeding the granular material prepared in step 3 into the injection molding machine through the feeding port, setting the injection speed to 70V/%, and setting the pressure to 80 bar, the standard samples of φ12 mmx10 mm were injection molded.

The properties were measured according to the testing methods and the results were shown in Table 2.

### Examples 2-8

The corresponding magnetic elastomers were prepared according to the method of Example 1 by using the components and weight percentages listed in Table 1. Their properties were measured according to the testing methods, and the results were shown in Table 2.

TABLE 1
Components and weight percentages of examples

| | | Example 1 | | Example 2 | |
|---|---|---|---|---|---|
| | | Components | wt % | Components | wt % |
| Magnet | SmFeN magnet | SmFeN magnet | 84.2 | SmFeN magnet | 73.06 |
| powders | powder | powder 1 | | powder 1 | |
| Binders | | TPU1 | 13.25 | TPU1 | 7.56 |
| | | | | TPE1 | 17.16 |
| Processing | Release agent | Release agent | 1.41 | Release agent | 1.23 |
| aids | Lubricants | Lubricant | 1.14 | Lubricant | 0.98 |

| | | Example 3 | | Example 4 | |
|---|---|---|---|---|---|
| | | Components | wt % | Components | wt % |
| Magnet | SmFeN magnet | SmFeN magnet | 67 | SmFeN magnet | 56.27 |
| powders | powder | powder 1 | | powder 2 | |
| | Ferrite Powder | / | / | Ferrite powder 1 | 11.76 |
| Binders | | TPU1 | 4.43 | TPU2 | 4.25 |
| | | TPE2 | 12.97 | TPE1 | 12.68 |
| Processing | | Release agent | 1.32 | Release agent | 1.21 |
| aids | | Lubricant | 1.06 | Lubricant | 0.96 |
| | | Flame retardant | 13.21 | Flame retardant | 12.86 |

| | | Example 5 | | Example 6 | |
|---|---|---|---|---|---|
| | | Components | wt % | Components | wt % |
| Magnet | SmFeN magnet | SmFeN magnet | 38.94 | SmFeN magnet | 30.37 |
| powders | powder | powder 2 | | powder 1 | |
| | Ferrite Powder | Ferrite Powder 2 | 13.66 | Ferrite Powder 2 | 13.59 |
| | NdFeB Magnet | / | / | Anisotropic | 13.40 |
| | powder | | | NdFeB Magnet | |
| | | | | powder | |
| Binder | | TPU2 | 7.69 | TPU3 | 10.77 |
| | | TPE2 | 18.94 | TPE2 | 12.27 |
| Processing | | Release agent | 1.25 | Release agent | 1.18 |
| aids | | Lubricants | 1 | Lubricant | 0.94 |
| | | Flame retardant | 18.52 | Flame retardant | 17.48 |
| | | Example 7 | | Example 8 | |
| | | Components | wt % | Components | wt % |
| Magnet | SmFeN magnet | SmFeN magnet | 9.19 | SmFeN magnet | 50.72 |
| powders | powder | powder 2 | | powder 1 | |
| | Ferrite Powder | Ferrite Powder 3 | 13.59 | Ferrite Powder 3 | 12.54 |
| | NdFeB Magnet | Isotropic NdFeB | 34.58 | / | / |
| | powder | Magnet powder | | | |
| Binders | | TPU3 | 10.77 | TPU3 | 9.93 |
| | | TPE3 | 12.27 | TPE1 | 11.32 |
| Processing | | Release agent | 1.18 | Release agent | 1.09 |
| aids | | Lubricant | 0.95 | Lubricant | 0.87 |
| | | Flame retardant | 17.48 | Flame retardant | 12.55 |

TABLE 2
Testing results

| Properties | | Example 1 | Example 2 | Example 3 |
|---|---|---|---|---|
| Magnetic | Maximum magnetic energy product | 10.794 | 4.779 | 3.813 |
| properties | (BH)max (MGOe) | | | |
| | Remanence Br (kGs) | 7.061 | 4.557 | 4.092 |
| | Intrinsic coercivity Hcj (kOe) | 8.584 | 9.609 | 8.883 |
| Mechanical | Tensile strength (MPa) | 4.8 | 1.4 | 1.5 |
| properties | Elongation at break (%) | 3.8 | 256 | 459 |
| | Shore hardness (A) | 90 | 65 | 55 |
| | Flexural modulus (MPa) | 172 | 65 | 54 |
| Burning | Flame retardance rating | V2 | V1 | V1 |
| properties | | | | |
| Properties | | Example 4 | Example 5 | Example 6 |
| Magnetic | Maximum magnetic energy product | 4.641 | 1.353 | 1.598 |
| properties | (BH)max (MGOe) | | | |
| | Remanence Br (kGs) | 4.512 | 2.387 | 2.561 |
| | Intrinsic coercivity Hcj (kOe) | 9.028 | 8.59 | 11.092 |
| Mechanical | Tensile strength (MPa) | 1.7 | / | / |
| properties | Elongation at break (%) | 355 | 1623 | 1592 |
| | Shore hardness (A) | 60 | 40 | 40 |
| | Flexural modulus (MPa) | 68 | 35 | 41 |
| Burning | Flame retardance rating | V1 | V0 | V0 |
| properties | | | | |

| Properties | | Example 7 | Example 8 |
|---|---|---|---|
| Magnetic | Maximum magnetic energy | 1.103 | 2.836 |
| properties | product (BH)max (MGOe) | | |
| | Remanence Br (kGs) | 1.981 | 3.069 |
| | Intrinsic coercivity Hcj (kOe) | 11.916 | 8.319 |
| Mechanical | Tensile strength (MPa) | / | / |
| properties | Elongation at break (%) | 1855 | 939 |
| | Shore hardness (A) | 30 | 45 |
| | Flexural modulus (MPa) | 26 | 45 |
| Burning | Flame retardance rating | V0 | V0 |
| properties | | | |

### Examples 9-11

The corresponding magnetic elastomers were prepared according to the method of Example 1 by using the components and weight percentages listed in Table 3. Their properties were measured according to the testing methods, and the results were shown in Table 4.

TABLE 3
NdFeN Magnet powder Examples

| | | Example 9 | | Example 10 | | Example 1 | |
|---|---|---|---|---|---|---|---|
| | | Components | wt % | Components | wt % | Components | wt % |
| Magnet | SmFeN | NdFeN magnet | 84.2 | NdFeN | 56.27 | NdFeN | 9.19 |
| powders | magnet | powder 1 | | magnet | | magnet | |
| | powder | | | powder 2 | | powder 2 | |
| | Ferrite | / | / | Ferrite | 11.76 | Ferrite Powder | 13.59 |
| | Powder | | | powder 1 | | 3 | |
| | NdFeB | / | / | / | / | Isotropic | 34.58 |
| | Magnet | | | | | NdFeB | |
| | powders | | | | | Magnet | |
| | | | | | | powder | |
| Binders | | TPU1 | 13.25 | TPU2 | 4.25 | TPU3 | 10.77 |
| | | / | / | TPE1 | 12.68 | TPE3 | 12.27 |
| Processing | | Release agent | 1.41 | Release agent | 1.21 | Release agent | 1.18 |
| aids | | Lubricant | 1.14 | Lubricant | 0.96 | Lubricants | 0.95 |
| | | / | / | Flame | 12.86 | Flame | 17.48 |
| | | | | retardant | | retardant | |

TABLE 4
Testing results of NdFeN magnet powder examples

| Properties | | Example 9 | Example 10 | Example 11 |
|---|---|---|---|---|
| Magnetic | Maximum magnetic energy | 3.508 | 2.569 | 3.508 |
| properties | product (BH)max (MGOe) | | | |
| | Remanence Br (kGs) | 3.982 | 2.956 | 3.982 |
| | Intrinsic coercivity Hcj (kOe) | 4.322 | 3.225 | 4.322 |
| Mechanical | Tensile strength (MPa) | 1.6 | 1.7 | / |
| properties | Elongation at break (%) | 4.3 | 365 | 1956 |
| | Shore hardness (A) | 80 | 55 | 30 |
| | Flexural modulus (MPa) | 145 | 65 | 25 |
| Burning | Flame retardance rating | V2 | V1 | V0 |
| properties | | | | |

### Comparative Example 1 (Comparing With Example 1)

1. The binder TPUI was dried in a dryer at 80° C. for 2 hours;
2. 84.2 wt % of samarium iron nitrogen magnet powder 3, 13.25 wt % of TPU 1, and 2.55 wt % of the processing aids (1.41% of release agent and 1.14% of lubricant) were charged into a mixer and mixing for 30 minutes;
3. The temperature of each section of the twin-screw extruder was set between 130° C. and 230° C., and increased from the feed port to the discharge port. The mixed material of step 2 was fed into the feed port through an automatic feeder, and after being air-cooled on a conveyor belt, it was prepared into pellets with a diameter of 2-3 mm and a length of 3-5 mm by an automatic pelletizer.
4. The barrel temperature of the injection molding machine was set to 230° C. (actual measurement), the nozzle temperature to 250° C. (actual measurement), and the mold temperature to 50° C. (actual measurement). Turning on power supply of the electromagnetic field orientation, the orientation field was set to 6 kOe. After feeding the granular material prepared in step 3 into the injection molding machine through the feeding port, setting the injection speed to 70V/%, and setting the pressure to 80 bar, the standard samples of φ12 mmx10 mm were injection molded.

### Comparative Example 2 (Comparing With Example 4)

1. The binders TPU2 and TPE1 were dried in a dryer at 80° C. for 2 hours.
2. 56.27 wt % of Samarium iron nitrogen magnet powder 3, 11.76% of ferrite magnet powder 1, 4.25 wt % of TPU2, 12.68% of TPE1, 2.17 wt % of processing aids (1.21% of release agent, 0.96% of lubricant), and 12.86% of flame retardant were charged into a mixer and mix for 30 minutes.
3. The temperature of each section of the twin-screw extruder was set between 130° C. and 230° C., and increased from the feed port to the discharge port. The mixed material of step 2 was fed into the feed port through an automatic feeder, and after being air-cooled on a conveyor belt, it was prepared into pellets with a diameter of 2-3 mm and a length of 3-5 mm by an automatic pelletizer.
4. The barrel temperature of the injection molding machine was set to 230° C. (actual measurement), the nozzle temperature was set to 250° C. (actual measurement), and the mold temperature was set to 50° C. (actual measurement). The electromagnetic field orientation power supply was turned on, and the orientation field was set to 6 kOe. After feeding the granular material prepared in step 3 into the injection molding machine through the feeding port, setting the injection speed to 70V/%, and setting the pressure to 80 bar, the standard samples of φ12 mmx10 mm were injection molded.

### Comparative Example 3 (Comparing With Example 6)

1. The binders TPU3 and TPE2 were dried in a dryer at 80° C. for 2 hours.
2. 30.37 wt % of samarium iron nitrogen magnet powder 3, 13.59% of ferrite magnet powder 2, 13.4% of anisotropic neodymium iron boron magnet powder, 10.77 wt % of TPU3, 12.27% of TPE2, and 2.12 wt % of processing aids (including 1.18% of release agent and 0.94% and lubricant), and 17.48% of flame retardant were charged into a mixer and mix for 30 minutes.
3. The temperature of each section of a twin-screw extruder was set between 130° C. and 230° C., and increased from the feed port to the discharge port. The mixed material of step 2 was fed into the feed port through an automatic feeder, and after being air-cooled on a conveyor belt, it was prepared into pellets with a diameter of 2-3 mm and a length of 3-5 mm by an automatic pelletizer.
4. The barrel temperature of the injection molding machine was set to 230° C. (actual measurement), the nozzle temperature was set to 250° C. (actual measurement), and the mold temperature was set to 50° C. (actual measurement). The electromagnetic field orientation power supply was turned on, and the orientation field was set to 6 kOe. After feeding the granular material prepared in step 3 into the injection molding machine through the feeding port, and setting the injection speed to 70V/% and the pressure to 80 bar, the standard samples of φ12 mmx10 mm were injection molded.

### Comparative Example 4 (Comparing With Example 9)

1. The binder TPUI was dried in a dryer at 80° C. for 2 hours.
2. 84.2 wt % of NdFeN magnet powder 3, 13.25 wt % of TPU 1, and 2.55 wt % of processing aids (including 1.41% of release agent and 1.14% of lubricant) were charged into a mixer and mix for 30 minutes.
3. The temperature of each section of a twin-screw extruder was set between 130° C. and 230° C., and increased from the feed port to the discharge port. The mixed material of step 2 was fed into the feed port through an automatic feeder, and after being air-cooled on a conveyor belt, it was prepared into pellets with a diameter of 2-3 mm and a length of 3-5 mm by an automatic pelletizer.
4. The barrel temperature of the injection molding machine was set to 230° C. (actual measurement), the nozzle temperature was set to 250° C. (actual measurement), and the mold temperature was set to 50° C. (actual measurement). The electromagnetic field orientation power supply was turned on, and the orientation field was set to 6 kOe. After feeding the granular material prepared in step 3 into the injection molding machine through the feeding port, setting the injection speed to 70V/%, and setting the pressure to 80 bar, the standard samples of φ12 mmx10 mm were injection molded.

The properties were measured according to the testing methods and the results were shown in Table 5.

TABLE 5
Testing results of comparative examples

| Properties | | CE 1 | CE 2 | CE 3 | CE 4 |
|---|---|---|---|---|---|
| Magnetic | Maximum magnetic energy | 6.533 | 3.557 | 1.113 | 2.339 |
| properties | product (BH)max (MGOe) | | | | |
| | Remanence Br (kGs) | 5.055 | 3.502 | 1.890 | 2.569 |
| | Intrinsic coercivity Hcj (kOe) | 6.203 | 7.822 | 9.223 | 1.578 |
| Mechanical | Tensile strength (MPa) | 1.5 | 1.4 | / | 2.3 |
| properties | Elongation at break (%) | 1.2 | 123 | 1176 | 1.3 |
| | Shore hardness (A) | 100 | 80 | 70 | 85 |
| | Flexural modulus (MPa) | 225 | 127 | 86 | 180 |
| Burning | Flame retardance rating | V2 | V1 | V0 | V2 |
| properties | | | | | |

The results show that under the same ratio and molding method, if the samarium iron nitrogen magnet powder within the particle size range of this disclosure is not selected, the magnetic properties and mechanical properties of the obtained magnetic elastomer are poor, especially having a high flexural elastic modulus, that is, the flexibility is relatively poor. If the neodymium iron nitrogen magnet powder within the particle size range of this disclosure is not selected, the magnetic properties of the obtained magnetic elastomer are poor and the flexibility is also relatively poor.

The present disclosure has been described above in conjunction with preferred embodiments, but these embodiments are only exemplary and serve only as an illustration. On this basis, various replacements and improvements may be made to the present disclosure, all of which fall within the scope of protection of the present disclosure.

1. A magnetic elastomer comprising the following components based on the total weight of the magnetic elastomer:
50 wt %-85 wt % of a magnet powder,
5 wt %-30 wt % of a binder, and
1 wt %-30 wt % of a processing aid,
wherein the magnet powder comprises a samarium iron nitrogen magnet powder and/or a neodymium iron nitrogen magnet powder; and
wherein, when present, the samarium iron nitrogen magnet powder has an x50 particle size of less than or equal to 2.4 μm; when present, the neodymium iron nitrogen magnet powder has an x50 particle size of less than or equal to 2.0 μm.

2. The magnetic elastomer according to claim 1, wherein the binder is a thermoplastic elastic material having a melting point of between 80 degrees Celsius and 200 degrees Celsius.

3. The magnetic elastomer according to claim 2, wherein the binder is selected from the group consisting of styrene-based thermoplastic elastomers, olefin-based thermoplastic elastomers, diene-based thermoplastic elastomers, vinyl chloride-based thermoplastic elastomers, urethane-based (TPU) thermoplastic elastomers, ester-based (TPEE) thermoplastic elastomers, amide-based (TPAE) thermoplastic elastomers, organic fluorine-based (TPF) thermoplastic elastomers, thermoplastic resins (EEA) and silicone-based thermoplastic elastomers.

4. The magnetic elastomer according to claim 1, wherein the processing aid comprises at least one of a coupling agent, a plasticizer, a mold release lubricant, and a flame retardant.

5. The magnetic elastomer according to claim 1, wherein the magnet powder further comprises a second magnet powder, preferably, the second magnet powder is selected from the group consisting of ferrite magnet powders and neodymium iron boron magnet powders;
the samarium iron nitrogen magnet powder and/or the neodymium iron nitrogen magnet powder are present in a total amount of 15-100 wt %, based on the total weight of the magnet powder; the second magnet powder is present in a total amount of 0-85%, based on the total weight of the magnet powder.

6. The magnetic elastomer according to claim 5, wherein the samarium iron nitrogen magnet powder and/or the neodymium iron nitrogen magnet powder are present in a total amount of 10-76 wt %, based on the total weight of the magnet powder; the second magnet powder is present in a total amount of 10-40 wt %, based on the total weight of the magnet powder.

7. The magnetic elastomer according to claim 1, wherein:
SmFeN magnet powder has an x10 particle size of 0.6-1.0 μm, an x50 particle size of 1.9-2.4 μm, and an x99 particle size of 5.5-7.2 μm; and/or
NdFeN magnet powder has an x10 particle size of 0.5-0.8 μm, an x50 particle size of 1.5-2.0 μm, and an x99 particle size of 4.5 6.2 μm.

8. The magnetic elastomer according to claim 7, wherein:
SmFeN magnet powder has a maximum magnetic energy product (BH)max of 28-41 MGOe, a remanence Br of 12.5-15.0 kGs, and an intrinsic coercivity Hcj of 8.0-12.0 kOe; and/or
NdFeN magnet powder has a maximum magnetic energy product (BH)max of 9-22 MGOe, a remanence Br of 10.0-14.0 kGs, and an intrinsic coercivity Hcj of 3.0-8.0 kOe.

9. The magnetic elastomer according to claim 1, wherein the magnetic elastomer comprises the following components based on the total weight of the magnetic elastomer:
80 wt %-85 wt % of the magnet powder,
8 wt %-20 wt % of the binder, and
1 wt %-3 wt % of the processing aid,
wherein the processing aid does not contain a flame retardant.

10. The magnetic elastomer according to claim 9, wherein the magnetic elastomer has a maximum magnetic energy product (BH)max of above 8 MGOe, a tensile strength of between 2 MPa and 10 MPa, an elongation at break of between 2% and 5%, a Shore hardness of below 90 A, and a flexural modulus of between 90 MPa and 200 MPa.

11. The magnetic elastomer according to claim 1, wherein the magnetic elastomer comprises the following components based on the total weight of the magnetic elastomer:
55 wt %-80 wt % of the magnet powder,
15 wt %-25 wt % of the binder, and
2 wt %-30 wt % of the processing aid,
wherein the processing aid comprises a flame retardant.

12. The magnetic elastomer according to claim 11, wherein the magnetic elastomer has a maximum magnetic energy product (BH)max of between 4 and 8 MGOe, a tensile strength of below 2 MPa, an elongation at break of between 3% and 500%, a Shore hardness of below 70 A, a flexural elastic modulus of between 30 and 100 MPa, and a flame retardance rating of V1 or above according to UL94 standards.

13. The magnetic elastomer according to claim 1, wherein the magnetic elastomer comprises the following components based on the total weight of the magnetic elastomer:
50 wt %-70 wt % of the magnet powder,
15 wt %-30 wt % of the binder, and
10 wt %-25 wt % of the processing aid,
wherein the processing aid comprise a flame retardant.

14. The magnetic elastomer according to claim 13, wherein the magnetic elastomer has a maximum magnetic energy product (BH)max of between 1 and 4 MGOe, an elongation at break of between 500% and 2000%, a Shore hardness of below 50 A, a flexural elastic modulus of between 2 and 50 MPa, and a flame retardance rating of V0 or above according to UL94 standards.

15. A method for preparing a magnetic elastomer, comprising:
S1. providing a magnetic elastomer composition comprising the following components based on the total weight of the magnetic elastomer composition:
50 wt %-85 wt % of a magnet powder,
8 wt %-30 wt % of a binder, and
1 wt %-30 wt % of a processing aid,
wherein, the magnet powder comprises samarium iron nitrogen magnet powder and/or neodymium iron nitrogen magnet powder; and
wherein, when present, the samarium iron nitrogen magnet powder has an x50 particle size of 1.9-2.4 μm; when present, the neodymium iron nitrogen magnet powder has an x50 particle size of 1.5-2.0 μm;
S2. molding the magnetic elastomer composition under a condition having an orientation field of greater than 5 kOe to obtain the magnetic elastomer.

16. An article comprising the magnetic elastomer according to claim 1.
